(19) United States
(12) Patent Application Publication
(10) Pub. No.: US 2013/0037289 A1
(43) Pub. Date: Feb. 14, 2013

(54) ELECTRIC HAMMER

(71) Applicant: Mohammed M. Al-Mutairi, Al-Fahaheel (KW)

(72) Inventor: Mohammed M. Al-Mutairi, Al-Fahaheel (KW)

(21) Appl. No.: 13/208,077

(22) Filed: Aug. 11, 2011

(51) Int. Cl. B25D 11/04

(52) U.S. Cl. 173/117

(57) ABSTRACT

A electric hammer includes a generally pistol shaped housing with a grip portion, a barrel portion and an electric motor and battery pack disposed in the grip portion. The motor includes an output shaft that extends upwardly into the barrel portion, a cylindrical drum fixed to the shaft with a generally flat upper surface and peripheral edge. The drum in the shape of a right circular cylinder includes a cavity or short passageway extending from the upper surface into the interior thereof. A longitudinally extending rod with a short transverse portion extending into the cavity so that the rotation of the drum provides reciprocal movement of the rod causing a hammer head to repeatedly strike a nail head. An important feature of the hammer resides in a tubular member with a tapered bore running through the barrel portion of the electric hammer allowing for limited lateral movement of the elongated rod as it repeatedly strikes the head of a nail with a solid metal hammer head.

### FIELD OF THE INVENTION

This invention relates to an electric hammer and more particularly to an electric hammer that resembles a ¼″ electric drill and which includes a rechargeable battery pack for energizing said hammer.

### BACKGROUND FOR THE INVENTION

Electric hammers and hammer-drills are well known and have been in use for many years. For example, a portable electric tool is disclosed in a U.S. patent of Zander et al., U.S. Pat. No. 3,736,992. As disclosed a portable electric tool having a motor supported within a housing and adapted to rotate an output shaft. A toothed, hammer member is fixed to the output shaft and when engaged with a stationary tooth member, imparts longitudinal impact blows to the output shaft during rotation thereof. An adjustable collar supports the shaft in the tool housing and is operable, in one position of adjustment, to allow the toothed members to engage, and in another adjusted position, to prevent the toothed members from engaging. The collar embodies in a novel, simplified construction and is frictionally retained in position during use of the tool. In addition, a novel bearing arrangement is provided between the collar and the shaft to insure proper lubrication of the shaft during use of the tool.

An additional U.S. Pat. No. 4,237,987 of Sherman, discloses a percussive tool that includes a tool member and a member imparting strikes to the former. The tool member is located in a tool casing which is moveable relative to a housing. A spring is located between the tool casing and the housing so as to substantially prevent transmission of impacts from the former to the latter. The tool housing is provided with a recess at a trailing end thereof into which a leading end of the imparting member can be received whereby the imparting member does not make contact with the tool casing. The axial length of the recess is such that when the tool casing is urged rearwardly to its initial position, a wall surrounding the recess surrounds the leading end of the imparting member.

A more recent U.S. Pat. No. 4,468,826 of Moores, Jr. discloses a hammer-drill that is adapted for drilling a hole in masonry and subsequently driving a threaded masonry fastener therein. The hammer-drill has a driving output shaft nested concentrically within a driving output sleeve. The shaft and sleeve both extend forwardly of the tool housing, and both are driven continuously by respective gearing in the tool. The sleeve, however, is driven at a substantially lower RPM than the shaft and at a higher torque. After the hole is drilled, a tubular member is releaseably and drivingly coupled to the sleeve. The tubular member encloses the masonry drill bit which is continually rotated, and the drill bit need not be removed from the tool to seat the fastener. The tubular member has a forward portion provided with a socket for the head of the masonry fastener.

A still further U.S. Pat. No. 7,237,621 of Hsieh discloses a driving device. The Hsieh patent discloses a driving unit comprising a pneumatic head for being combined with a pneumatic tool; a front end of the pneumatic head being installed with a push rod. In addition a driving unit having a slender driving rod at a front end thereof and the push rod serving to push the driving unit. Also, an elastomer, a casing having a receiving space are included and the elastomer being received in an upper end of the receiving space; and the driving unit being received in an upper end of the receiving space and resisting against the elastomer. The tool includes a rotating unit having an engaging portion at a lower end thereof; the rotating unit being received in a lower end of the receiving space; and an upper side of the rotating unit having a contact portion. The configuration of the contact portion is such that is corresponds to one end portion of the driving unit.

Notwithstanding the above, it is presently believed that there is a need for an improved electric hammer and a potential commercial market for the improved electric hammer in accordance with the present invention. There should be a commercial market for such hammers because they are of relatively simple design, rugged, long lasting, relatively maintenance free, portable and capable of being manufactured and sold at a reasonable cost. Further, such hammers are relatively easy to use, superior to and faster than manual hammers, less likely to strike one's finger or hands and accurate in the placement of fasteners such as nails and the like.

### BRIEF SUMMARY OF THE INVENTION

An electric hammer in accordance with the present invention includes a housing and an electric motor disposed in the housing. The motor includes an output shaft, a rotatable drum fixed to the output shaft at one end thereof and the rotatable drum having an upper surface, a peripheral edge and a cavity extending inwardly from the upper surface at a angle of about 90 degrees near the peripheral edge. The hammer also includes a solid metal hammer head and a longitudinal rod having a transverse portion at one end thereof for fitting into the passage way in the rotatable drum. An opposite end of the rod is constructed and arranged to repeatedly strike said hammer head to thereby drive the hammer head against the head of a nail in response to the rotation of the rotatable drum. The electric hammer also includes means including a longitudinally extending tube for limiting lateral movement of the rod as the rod moves back and forth in response to rotation of the rotatable drum.

The invention will now be described in connection with the accompanying drawings wherein like reference numerals have been used to indicate like parts.

### DESCRIPTION OF THE DRAWINGS

FIG. 1 is a side elevational view of an electric hammer in accordance with a first embodiment of the invention;

FIG. 2 is a cross-sectional view of the electric hammer shown in FIG. 1;

FIG. 3 is a schematic section of the electric hammer shown in FIG. 2; and

FIG. 4 is a sectional perspective view of the electric hammer shown in FIGS. 1-3.

### DESCRIPTION OF THE PREFERRED EMBODIMENTS OF THE INVENTION

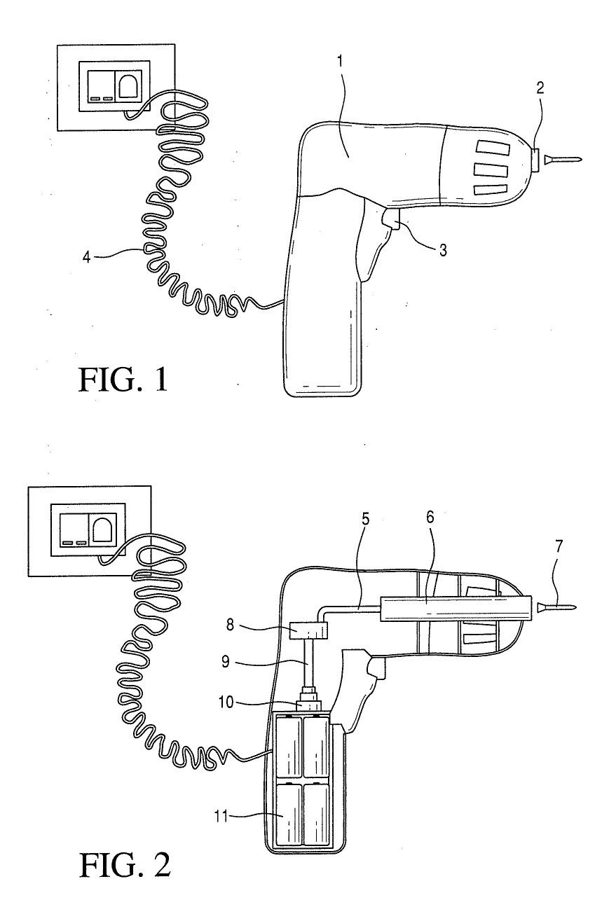

As illustrated in FIG. 1, an electric hammer 20 in accordance with the preferred embodiment of the invention includes a general pistol shaped metal housing 22 that closely resembles the shape of a typical ¼ or ⅜ inch electric drill. The housing 22 includes a barrel portion 24 and grip portion 26 that extends downwardly from a rear part of the barrel portion 24 at an angle of about 90 degrees. The housing is preferably made of cast aluminum with a forward part 28 of the barrel portion 24 of sheet metal.

As shown, the hammer 20 includes an electrical cord 25 that extends from a lower part of the grip portion 26 to a remote electrical charger 30 or to a source of DC power for energizing a DC motor not shown in FIG. 1. The motor is activated by a trigger 32. A solid metal hammer head 34 is adapted to engage the head of a nail 31.

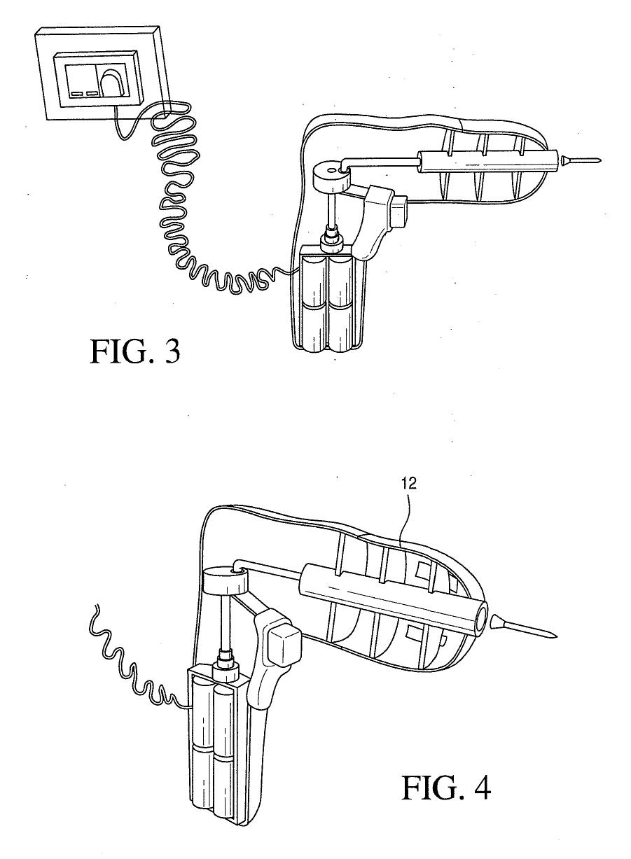

As illustrated in FIGS. 2-4, the electric hammer 20 includes a DC electric motor 33 shown schematically that is disposed in the grip portion 26 of the housing 22. As shown, a majority of the motor 33 is behind a battery pack 35 that powers the motor 33. The motor 33 includes an output shaft 37 that extends upwardly out of the motor 33 and into the barrel portion 24 of the housing 22. A drum 38 is fixed to the upper end of the output shaft 37 for rotation by the shaft 37.

The drum 38 is in the shape of a right circular cylinder and includes an upper surface 38 an outer peripheral edge with a cavity or passageway extending into the drum near its peripheral edge. The hammer 20 also includes a longitudinally extending rod 39 with a short transverse portion 40 at one end thereof. The transverse portion 40 extends into the cavity or passageway in the drum 38 that reciprocates the rod 39 back and forth along the barrel portion 24. As shown, an opposite end of the rod 39 is in contact with the hammer head 34.

As the longitudinally extending rod 39 is reciprocated in the barrel portion 24 it moves back and forth at relatively high speed by the rotation of the cylindrical drum 38 causing the hammer head 34 to repeatedly strike the head of a nail 31 or the like. An important feature of the present invention resides in a longitudinally extending tubular member 42 that is disposed in the barrel portion 24 of the electric hammer 20.

The longitudinally extending tubular member 42 is fixed in place by a plurality of notches that engage three fixed wall members 41, 43, and 45 as well as a forward part 28 of the barrel portion 24 of the hammer 22. In a preferred embodiment of the invention the longitudinally extending tubular member has a tapered passageway extending through the tubular member 42 that is slightly wider at the rear portion and narrower in a front part thereof to allow for lateral displacement of the rod 39 due to the rotation of the drum 38 about a generally vertical axis.

While the invention has been described in connection with its preferred embodiment it should be recognized that changes and modifications may be made therein without departing from the scope of the appended claims.

What is claimed is:

1. An electric hammer comprising a housing and an electric motor disposed in said housing and said motor including an output shaft, a rotatable drum fixed to said output shaft and said rotatable drum having an upper flat surface, a peripheral edge and a cavity or passageway extending inwardly from said upper surface at an angle of about 90° near said peripheral edge, and a solid hammer head and a longitudinal rod having a relatively short transverse portion at one end thereof for fitting into said passageway in said rotatable drum and an opposite end of said rod constructed and arranged to repeatedly strke said hammer head to thereby drive said hammer head against the head of a nail in response to the rotation of said rotatable drum and said electric hammer including means including a longitudinally extending tube for limiting lateral movement of said rod as said rod moves back and forth in response to rotation of said rotatable drum.

2. An electric hammer according to claim 1 in which said hammer is in the general shape of a pistol or a ¼ inch electric drill having a handle portion and a barrel portion.

3. An electric hammer according to claim 2 in which said electric motor is disposed in said handle portion and said elongated rod extends along said barrel portion.

4. An electric hammer according to claim 3 in which said electric hammer includes a rechargeable battery pack for powering said electric hammer.

5. An electric hammer according to claim 4 which includes means for returning said hammer head to a withdrawn portion after each strike to a nail head.

6. An electric hammer according to claim 5 in which said means for rotating the hammer head to a withdrawn portion includes a coil spring.

7. An electric hammer consisting of:
a generally pistol shaped metal housing having a barrel portion and grip portion extending at about 90° from one end of said barrel portion and an electric motor disposed in said grip portion of said housing and said electric motor including a rotatable output shaft extending upwardly into said barrel portion of said hammer;
a rotatable drum fixed to one end of said shaft within said barrel portion of said housing and said rotatable drum having an upper generally flat surface, a peripheral edge and an inwardly extending cavity extending inwardly at an angle of about 90° with respect to said upper surface and near said peripheral edge;
a solid metal head portion and a longitudinally extending rod having a transverse end portion extending into said cavity at an opposite end engaging said solid metal head whereby the rotation of said drum repeatedly displaces said rod through a distance approximately equal to the diameter of said drum to repeatedly strike a head of a nail or the like;
a series of supporting plates and a longitudinal extending tubular member having a tapered bore surrounding said rod and limiting lateral movement of said rod as said rod move back and forth in response to the rotation of said drum; and
a rechargeable battery pack for energizing said motor.
